(19) United States
(12) Patent Application Publication
(10) Pub. No.: US 2005/0225714 A1
(43) Pub. Date: Oct. 13, 2005

(54) Peripheral vision reflector

(76) Inventor: Peter Thir, LaPlata, MD (US)

Correspondence Address: W. Michael Cooper, P.O. Box 519, Hollywood, MD, 20636, US

(21) Appl. No.: 10/823,058

(22) Filed: Apr. 13, 2004

(51) Int. Cl. G02C 1/00; G02C 9/02

(52) U.S. Cl. 351/59

(57) ABSTRACT

An improved low vision device for macular degeneration victims comprising any one of the following elements; (1) two reflecting elements permanently affixed to the frame, (2) reflecting elements mounted to the frame along their outer edges, (3) a single unified lower reflecting element or frame, (4) a corrective lens pivotally attached to a reflecting element in such a way that it may be removed or rotated away, (5) a shield covering the frame that blocks ancillary light from entering the eye, (6) a shield attached to a reflecting element that blocks light from entering the eye between the upper and lower reflecting elements, and (7) a handheld design featuring two reflecting elements for use with only one eye.

### CROSS REFERENCE TO RELATED APPLICATIONS

Not Applicable.

### FEDERALLY SPONSORED RESEARCH

Not Applicable.

### SEQUENCE LISTING OR PROGRAM

Not Applicable.

### FIELD OF THE INVENTION

This invention relates to corrective low vision devices, specifically to improvements of low vision devices for macular degeneration victims.

### BACKGROUND OF THE INVENTION

Macular Degeneration is a disease affecting roughly 13 million Americans that causes visual impairment. Specifically, macular degeneration results in the deterioration of the macula. The macula is the light sensitive central portion of the retina. A healthy macula allows an individual to discern details in the center of their scope of vision. The deterioration of the macula due to macular degeneration typically causes blank or blurry spots in the central field of sight. Macular degeneration rarely affects peripheral vision.

There are two categories of macular degeneration. Atrophic, or “dry” type, progresses more slowly and has no known cure. Exudative, or “wet” type, is caused by the leakage of blood vessels beneath the retina and may progress more rapidly. There are few treatments for either type and existing treatments, especially for “dry” type macular degeneration, typically slow the progression of the disease, but do not provide a cure. Several low vision devices have become available to provide a solution for macular degeneration victims.

Adaptive low vision devices that shift images to the periphery of the eye allow an individual suffering from macular degeneration to use their unaffected peripheral vision to view images in their central line of vision. Early efforts at exploiting this concept resulted in prismatic devices such as those disclosed in U.S. Pat. No. 5,155,508 (1992) and U.S. Pat. No. 5,323,190 (1994) to Onufryk. The theory is that prisms may be used to redirect the incident light from an object to the periphery of the eye. These prismatic devices proved expensive to manufacture and were not adjustable. Changes in the optically responsive area of the victim's eye due to progression of the disease would require the replacement of the device. U.S. Pat. No. 6,299,304 to Demuth (2001) discloses a device that utilizes upper and lower reflective surfaces resistively pivotally attached to an eyeglass frame to redirect the incident light of a source object to the optically responsive portion of the periphery of the eye. As depicted, the incident light reflects off of the lower reflective surfaces to an upper reflective surface. The light then reflects off of the upper reflective surface downward to the top of the eye. The motivation claimed by this invention was to address the cost of manufacture and lack of adjustability of the prismatic devices. There are several problems with the invention disclosed in the Demuth patent.

In this patent application, “reflectors,” “reflecting elements,” and “reflecting optical elements” all refer to a component or subassembly of this invention that provides a reflective surface.

First, the resistive pivotal attachment does not prevent the relative movement of the reflectors due to the physical forces created by everyday use. The first and second reflecting optical elements must be particularly aligned to reflect the image onto the optically responsive portion of the eye. The attachment method disclosed in the Demuth patent allows these reflecting elements to easily become misaligned.

Second, it is contemplated by the Demuth patent that the reflectors would be hinged along their rear edge to the eyeglass frame. This causes the reflectors to protrude from the victim's face more than necessary. This also limits the area of the periphery of the eye that may be used.

Third, the lack of a connection between the two lower reflecting optical elements, as depicted, creates the potential for these elements to become misaligned with each other. In order for the image to appear the same to both eyes, the incident light from the source object should be reflected to the same part of each eye. To facilitate this, the two lower reflecting optical elements must remain coplanar with each other. This requirement for coplanar orientation makes the reflecting optical element difficult to initially align. Additionally, any movement of one element with respect to the other due to normal use and handling will cause a misalignment. By not providing for a single unitary bottom reflecting element or a frame for the bottom reflecting elements, the Demuth patent allows for the two bottom elements to become misaligned with respect to each other.

Fourth, the invention claimed by Demuth does not describe a method for attaching a corrective lens to the device. The Demuth patent claims the method of and the device which redirects light through a corrective lens but fails to address the need to remove this corrective lens, i.e., when using the device for something requiring extended sight. Essentially, the Demuth patent contemplates two scenarios: mounting the reflecting elements to a conventional eyeglass frame or creating an independent frame with the reflecting elements that would be mounted onto a conventional pair of eyeglasses. The need for different corrective lenses is addressed by the ability to remove the independent frame with the reflecting elements from one pair of eyeglasses and mount it onto another pair of eyeglasses with different corrective lenses. In this manner, it becomes easy for the reflecting elements to become misaligned due to the constant mounting and dismounting from various eyeglasses. More importantly, though, this allows very little flexibility in the type of corrective lenses used because the area of the corrective lens that the incident light passes through is very small compared to the normal use of such corrective lenses.

Fifth, the Demuth patent fails to address the adverse effect of ancillary light entering the eye from other sources. Ancillary light entering the field of view from sources other than the reflective optical elements significantly detracts from the effectiveness of the device. This is not addressed by the Demuth patent.

Sixth, a disruption in the image is created by the incident light from the source object that enters the eye directly, by passing between the upper and lower reflecting elements.

There is also a need for a more robust embodiment of this concept that may be used by individuals whose condition has not progressed to the point of needing to wear a corrective low vision aid continuously. A portable device that could be transported in handbag or pocket without fear of misalignment would address this concern.

The invention disclosed herein addresses each of these problems by making novel improvements to the device disclosed in the Demuth patent. The invention disclosed herein also provides a less expensive solution for individuals whose disease has not progressed to the point of needing a low vision device for all of their daily functions. The principle of two interactive reflecting optical elements is incorporated into a device used to enhance the vision of a single eye. This device provides an individual who still retains enough vision to perform daily functions with a solution for examining items in detail. The device may be carried in a pocket or handbag and used when needed as opposed to being worn for extended periods of time. This design is also more robust, thus providing increased protection from the normal effects of everyday use and storage.

The invention disclosed herein exhibits several novel and unique advantages over the prior art.

(a) The reflecting optical elements of the device disclosed herein are permanently affixed to the frame by methods of welding, brazing, or soldering. This drastically minimizes the potential for the lenses to become misaligned through the rigors of everyday use. Initial and subsequent adjustments to the lenses would be performed by bending the metal until the reflecting elements are properly aligned.

(b) The reflecting elements of the invention disclosed herein are mounted along their outside edges. This provides a stronger design by decreasing the length of the moment arm and the torque at the point of attachment. This also allows the reflecting element to be positioned closer to the face and thus not protrude as far from the face. Finally, this allows for aligned reflecting elements to use a greater portion of the periphery of the eye.

(c) The invention disclosed herein provides for either a single unitary lower reflecting element or a rigid frame supporting two individual reflecting elements in a coplanar orientation. This eliminates the risk of misaligning the two lower reflecting elements.

(d) This invention also exhibits the ability to attach a corrective lens to the upper reflecting element in such a manner that it may be swung upward and out of the way when not in use.

(e) The invention disclosed herein also includes a shield that fits over the frame for the purpose of blocking the ancillary light. This shield improves the effectiveness of the device by limiting the light entering the optically responsive portion of the eye to only that light reflected by the reflecting optical elements.

(f) The invention disclosed herein includes a direct vision shield that blocks the incident light from the source object that enter the eye directly by passing between the two reflecting elements. This shield may be placed on the leading edge of the reflecting element closest to the face or on the trailing edge of the forward reflecting element. Light passing between the two reflecting elements creates a confusing double image.

(g) This patent discloses a related device for use with one eye that uses the principal of two aligned reflecting optical elements to direct incident light from a source object to the optically responsive portion of the eye. The device would be carried on a lanyard or in a pocket or handbag and be used only when needed. The device is held to the patient's eye and rotated to match or determine the optically responsive portion of the periphery of the eye. This would provide a more economical solution for individuals whose condition has not progressed to the point of needing a low vision device for an extended period of time.

### SUMMARY OF THE INVENTION

This patent application discloses a low vision device incorporating any one of the following elements; (1) two reflecting element permanently affixed to the frame in such a way that the mounting point or frame may be physically bent to align the reflecting elements, (2) reflecting elements mounted to the frame along their outside edges, (3) a single unitary frame connecting the two lower reflecting elements, (4) a single lower reflecting element, (5) corrective lens pivotally attached to the leading edge of the forward reflecting element in such a way that it may be removed or swung away when not used, (6) a shield covering the frame that blocks ancillary light from entering the eye, (7) a shield attached to one of the reflecting elements that blocks light from entering the eye between the upper and lower reflecting elements, and (8) a handheld design for use with only one eye.

### DESCRIPTION OF THE DRAWINGS

In the drawings, closely related figures have the same number but different alphabetic suffixes.

FIG. 1 shows the invention claimed in claims 1 through 4 and claim 6.

FIG. 2 shows the claimed device with the improvements of claim 5.

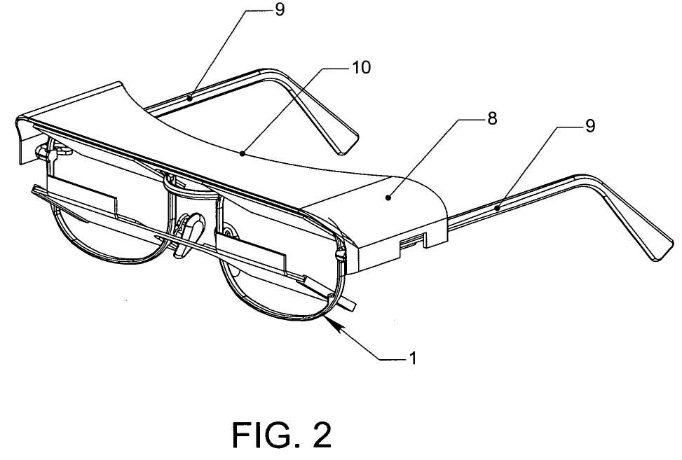

FIG. 3A shows the claimed device with the corrective lens of claim 7 in downward position. This is the configuration of the device when the corrective lens is being used.

FIG. 3B shows the same corrective lens of claim 7 in the upward position as it would be configured when not in use.

FIG. 4 shows the handheld device of claim 8 as designed for use with one eye.

### DESCRIPTION OF REFERENCE NUMERALS

1. Eyeglass Frame or Frame
2. Lower Reflector Frame
3. Lower Reflector
4. Upper Reflector Frame
5. Upper Reflector
6. Reflector Assembly Mounting Point
7. Direct Light Shield
8. Indirect Light Shield
9. Earpiece
10. Trailing Edge of Indirect Light Shield
11. Corrective Lens Frame
12. Corrective Lens
13. Tubular Frame
14. Forward Reflector
15. Aft Reflector

### DETAILED DESCRIPTION OF THE INVENTION

The Frame (1) is similar to a conventional eyeglass frame. The Lower Reflector Assembly comprises one or two Lower Reflectors (2) mounted to the Lower Reflector Frame (3). Similarly, the Upper Reflector Assembly comprises one or two Lower Reflectors (4) mounted to an Upper Reflector Frame (5). The preferred method for attaching the reflectors to the frame is by use of an adhesive. The upper and lower frames in the preferred embodiment are brazed, welded, or soldered to the frame at the Reflector Assembly Mounting Points. The upper and lower reflector frames may alternatively comprise a frame around the perimeter of the reflectors. The lower reflecting element may comprise a single unified reflecting surface mounted to a lower reflector frame to ensure the coplanar relationship of the left and right reflecting surfaces. In the preferred embodiment, incident light from the source object is reflected off of the upper reflecting element toward the lower reflecting element. The incident light then reflects off of the lower reflecting element to the bottom periphery of the eye. This orientation allows for the single unified design of the lower reflecting element in a small space and without significant protrusion of the device away from the individuals face. The preferred embodiments of the upper and lower reflecting elements may be conventional flat mirrors, mirrored polycarbonate, or highly polished metal.

The Indirect Light Shield (8) may be manufactured of metal, plastic, cloth, or other materials. This shield attaches to the frame at the points shown. The preferred embodiment comprises a rigid shield including fabrications at its edge that may be attached to the earpiece (9) or top edge of the frame (1). The trailing edge of the shield (10) is contoured to fit the typical profile of an individual's forehead. The trailing edge interface may include a pliable material for the purpose of increased comfort.

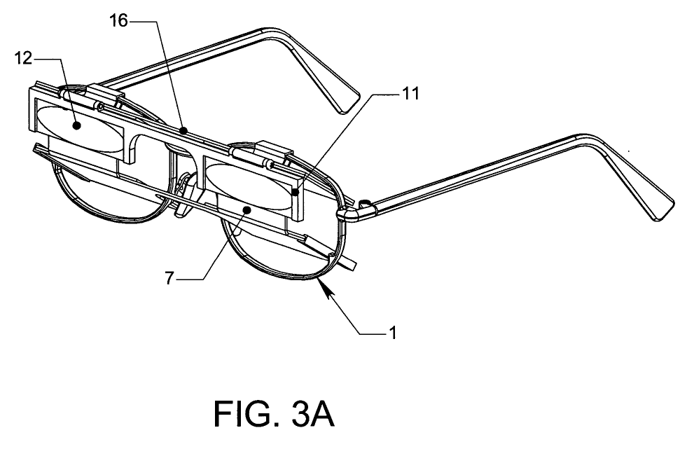

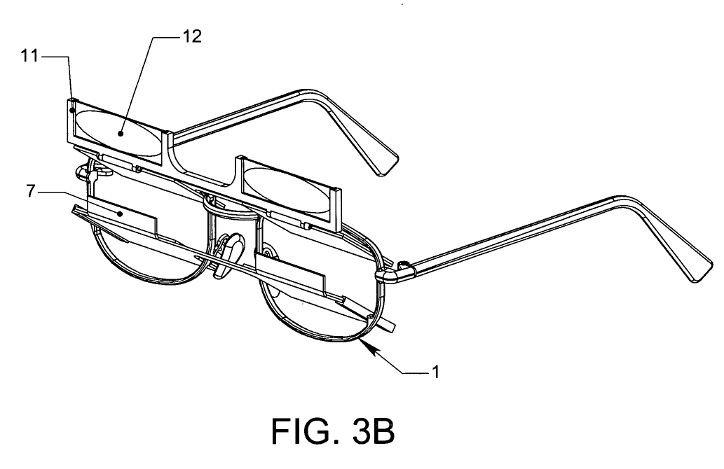

FIGS. 3A and 3B show the addition of a Corrective Lens Frame (11) that is pivotally mounted to the eyeglass frame. As depicted, two Corrective Lenses (12) are mounted to the corrective lens frame. The corrective lens frame may be pivoted downward when in use or upward when not in use. The corrective lens frame may be attached in other orientations. When in use, the incident light is directed through the corrective lens to the first reflective element and then reflected to the second reflective element and subsequently, to the optically responsive portion or each eye.

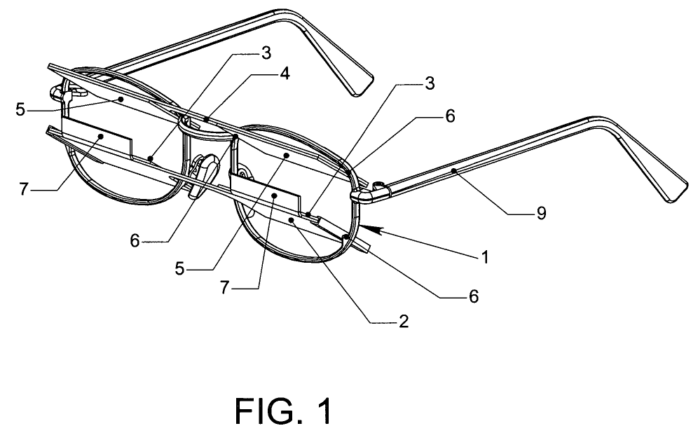

Incident light from the source object directly entering the eye by passing between the upper and lower reflecting elements is quite disruptive to the image perceived by the user. FIG. 1 shows two Direct Light Shields (7) attached to the leading edge of the lower reflector assembly. The preferred embodiment comprises a molded plastic shield glued to the nonreflective surface of the lower reflector assembly and protruding straight upward from the leading edge of said reflecting element. However, this shield may comprise metal or other materials affixed in other ways to either reflecting element or to the frame.

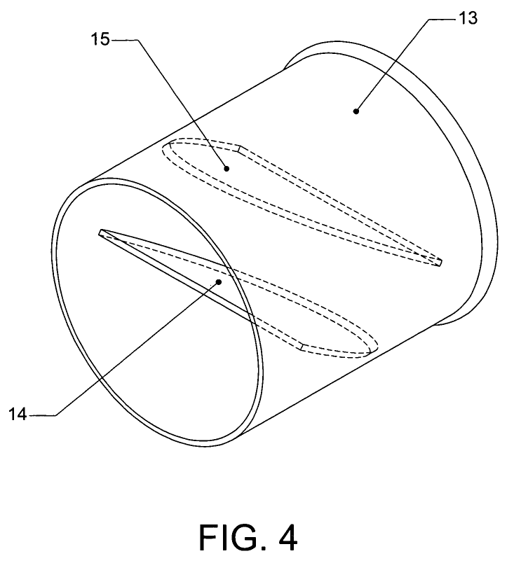

FIG. 4 depicts a device comprising a Forward Reflector (14) and an Aft Reflector (13) affixed to the interior of a Tubular Frame (12) in such a way that the incident light of the source object reflects off of the forward reflecting element to the aft reflecting element. The incident light then reflects off of the aft reflecting element to the periphery of the eye. The preferred embodiment comprises a plastic cylindrical frame with each reflecting element cut to fit into said tube in a particular orientation and glued into position in said tubular frame. However, the tubular frame may comprise any number of shapes.

Although the description above contains many specificities, these should not be construed as limiting the scope of the invention but as merely providing illustrations of some of the presently preferred embodiments of this invention. Thus, scope of the invention should be determined by the appended claims and their legal equivalents, rather than by the examples given.

1. A vision correcting device comprising:
a. a frame,
b. an upper reflecting element permanently affixed to said frame, and
c. one or more lower reflecting elements permanently affixed to said frame
where the reflecting elements are oriented in such a way that incident light from a visible object in front of a user is reflected off of one reflecting element to the other reflecting element where the incident light is then reflected to the periphery of the user's eye.

2. The device of claim 1 wherein said upper reflecting element and said lower reflecting elements may be positioned by physically bending said frame or physically bending the mounting point between any of said reflecting elements and said frame.

3. The device of claim 1 wherein any of said reflecting elements are mounted to said frame in such a way that the reflecting elements lie within the openings of the frame.

4. A vision correcting device comprising:
a. a frame,
b. an upper reflecting element, and
c. one or two lower reflecting elements mounted to a rigid frame in such a manner that the lower reflecting elements are held in a coplanar orientation and
where the reflecting elements are oriented in such a way that incident light from a visible object in front of a user is reflected off of one reflecting element to the other reflecting element and the incident light is then reflected to the periphery of the user's eve.

5. (canceled)

6. A vision correcting device comprising:
a. a frame,
b. one or more upper reflecting elements,
c. one or more lower reflecting elements, and
d. one or more shields positioned in such a manner as to prevent light from passing between said upper reflecting elements and said lower reflecting elements directly to the eye.

7. A vision correcting device comprising:
a. a frame,
b. one or more upper reflecting elements held within the upper reflector frame,
c. one or more lower reflecting elements, and
d. one or two corrective lens(es) mounted to a corrective lens frame that is pivotally attached to the leading edge of said upper reflector frame.

8. A device comprising:
a. a tubular frame,
b. a forward reflecting element,
c. an aft reflecting element,
d. whereby incident light from a source object is reflected off of said forward reflecting element to said aft reflecting element and off of said aft reflecting element to the optically responsive portion of the periphery of the eye, and
e. wherein said forward reflecting element and said aft reflecting element are affixed to the interior of said tubular frame.
